(19) United States
(12) Patent Application Publication
(10) Pub. No.: US 2022/0089062 A1
(43) Pub. Date: Mar. 24, 2022

(54) LEG UNIT FOR ATTACHING A SEAT IN A VEHICLE

(71) Applicant: Anjani Kumar, Northville, MI (US)

(72) Inventor: Anjani Kumar, Northville, MI (US)

(21) Appl. No.: 17/482,638

(22) Filed: Sep. 23, 2021

Related U.S. Application Data
(60) Provisional application No. 63/081,955, filed on Sep. 23, 2020.

(51) Int. Cl. B60N 2/015

(52) U.S. Cl. CPC B60N 2/015

(57) ABSTRACT

A leg unit for attaching a seat in a vehicle is disclosed. The unit includes at least one seat. The unit also includes at least one leg. Each of the at least one leg comprises at least one leg sub-unit, wherein the at least one leg includes at least three sections including a base section, a first section and a second section, wherein the first section and the second section are welded together via the base section. The at least one leg is housed on a flooring inside the vehicle. The leg unit also includes one or more set of holes, wherein the at least one seat is fixed to the flooring of the vehicle upon fixing one or more fasteners in the corresponding one or more set of holes to attach the at least one seat inside the vehicle.

### CROSS-REFERENCE TO RELATED APPLICATION

This application claims the benefit of provisional patent application having Patent Application No. 63/081,955 filed on Sep. 23, 2020 in the United States of America.

### FIELD OF INVENTION

Embodiments of a present disclosure relate to seats in a vehicle, and more particularly, to a leg unit for attaching one or more seats in a transit vehicle.

### BACKGROUND

With growth in automobile industries, certain types of vehicles such as transit vehicles are used for many purposes such as passenger travel, transportation of goods, transportation of passengers via a wheelchair, and the like. In a conventional approach, in order to enable different functionalities using the transit vehicle, multiple OEM (original equipment manufacturer) seats need to be either replaced or removed. In order to enable the transit van for mobility applications such as the wheelchair, the van floor requires an upfitting of wheelchair attachments, which is done either over plywood or over flexible flooring systems. Due to such upfitting, the factory seat tracks must be eliminated to level the surface to accept plywood or flexible metal floor, and as a result the OEM seats cannot be reinstalled to the plywood or flexible floor. Such limitations result in wastage of resources, because the van convertors must buy new seats to install on the van which increases the cost of the conversion, thereby making the conventional approach expensive, leading to a financial burden on the end users. In addition, seats and tracks must be installed in a fixed location and do not offer any flexibility in floorplans to the users.

Furthermore, due to rigid engineering of the seats, during accidents or any critical situation, the seat in the conventional vehicle puts an immense load on the plywood or flexible flooring system which results in destroying the flooring of the vehicle.

In addition, seat legs of such conventional vehicle have a hook feature in the front of the seat leg and a snapping mechanism at the back. It is not possible to install the seat on a flat surface without the complementary seat track. Furthermore, the floor is reinforced only at specific places, which means that the seats and tracks cannot be moved around because they cannot comply with applicable safety requirements. The original location of seats cannot be used because it is very unlikely that the location of seat is suitable for the end customer especially when 1 or 2 wheelchairs are added into the seating plan.

In addition, the spacing between the seat legs for single, double and triple seat remains fixed. For the seats to be used in mobility application, these seat legs should be adjustable along the width of the seat. This fixed spacing makes these seats un useable for mobility conversions.

Hence, there is a need for an improved a leg attachment unit to allow rearrangement of one or more seats in a mobility transit vehicle to address the above-mentioned issues.

### BRIEF DESCRIPTION

In accordance with one embodiment of the disclosure, a leg unit is disclosed for attaching a seat in a vehicle. The unit includes at least one seat. The unit also includes at least one leg. Each of the at least one leg comprises at least one leg sub-unit, wherein the at least one leg includes at least three sections including a base section, a first section of a first pre-defined shape and a second section of a second pre-defined shape, wherein the first section and the second section are welded together via the base section. The at least one leg is housed on a flooring inside the vehicle. The leg unit also includes one or more sets of holes, wherein the at least one seat is fixed to the flooring of the vehicle upon fixing one or more fasteners in the corresponding one or more set of holes to attach the at least one seat inside the vehicle.

To further clarify the advantages and features of the present disclosure, a more particular description of the disclosure will follow by reference to specific embodiments thereof, which are illustrated in the appended figures. These figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which.

FIG. 1 is a schematic representation of a leg attachment unit for mobility of a seat in a vehicle in accordance with an embodiment of the present disclosure;

FIG. 2 is a schematic representation of a replacement of a conventional leg arrangement of an OEM seat by the leg attachment unit of FIG. 1 in accordance with an embodiment of the present disclosure;

FIG. 3 is a schematic representation of a side view of the leg attachment unit of FIG. 1 in accordance with an embodiment of the present disclosure;

FIGS. 4a-4c is a schematic representation of the leg attachment unit for one seat, two seats and three seats respectively of FIG. 1 in accordance with an embodiment of the present disclosure;

FIG. 5 is a schematic representation of three set of holes for installing for one seat, two seats and three seats of FIGS. 4a-4c in respectively accordance with an embodiment of the present disclosure;

FIG. 6 is a schematic representation of the leg unit for the single seat being housed on the flooring inside the vehicle of FIG. 1 in accordance with an embodiment of the present disclosure;

FIG. 7 is a schematic representation of the leg unit for the two seats being housed on the flooring inside the vehicle of FIG. 1 in accordance with an embodiment of the present disclosure;

FIG. 8 is a schematic representation of the leg unit for the three seats being housed on the flooring inside the vehicle of FIG. 1 in accordance with an embodiment of the present disclosure; and

FIG. 9 is a schematic representation of a design of the leg attached to the floor of the vehicle of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a leg attachment unit for mobility of at least one seat in a vehicle. It should be noted that the present invention focusses on replacing a set of legs manufactured and installed by original equipment manufacturer (OEM) with a set of legs disclosed in the present invention.

In one embodiment, the vehicle may be a transit vehicle which may be used for multiple applications. In one specific embodiment, the seat also corresponds to an OEM (original equipment manufacturer) seat which is manufactured and is installed by the original equipment manufacturer inside the vehicle.

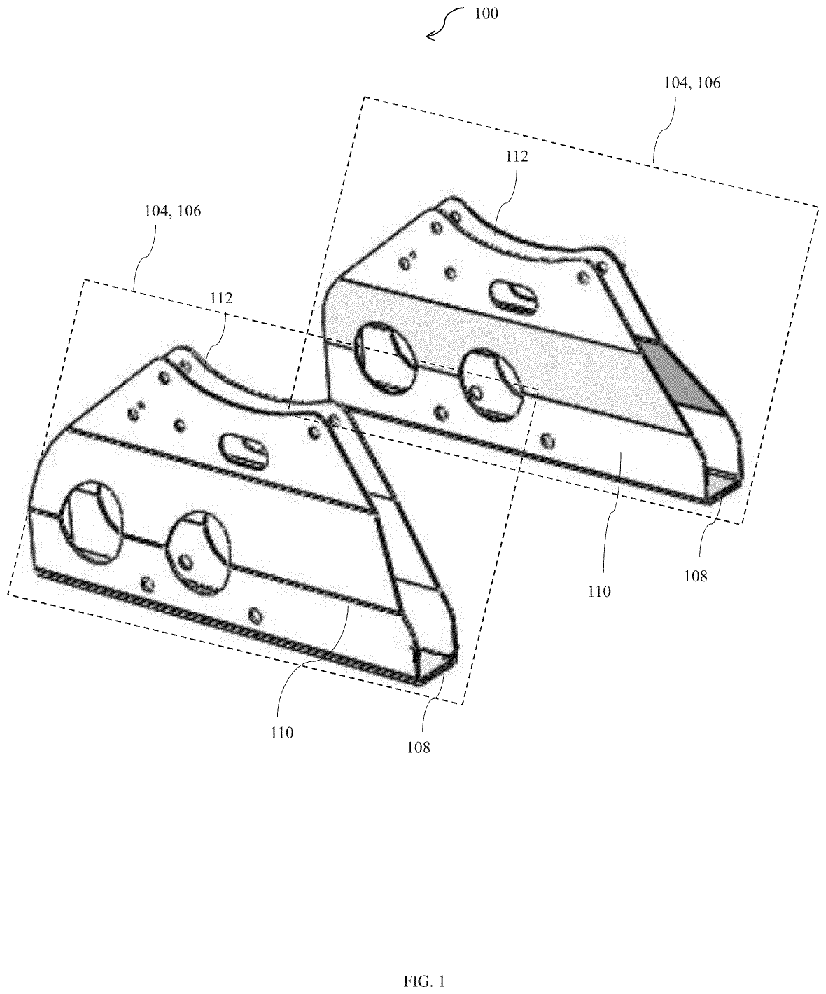

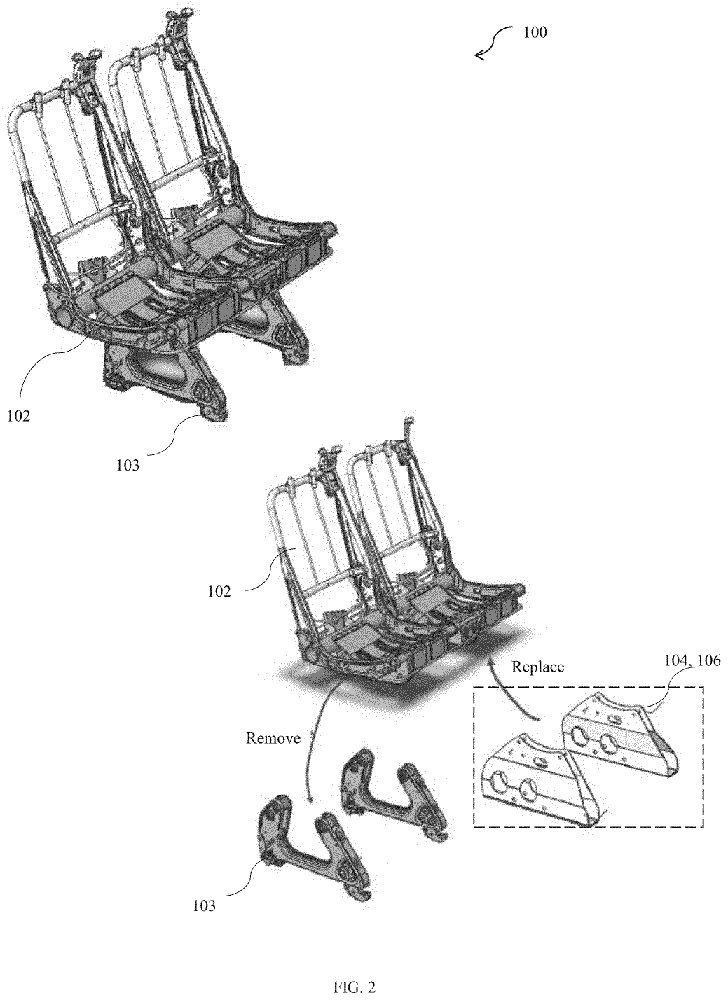

FIG. 1 is a schematic representation of a leg attachment unit 100 for mobility of a seat in a vehicle in accordance with an embodiment of the present disclosure. The leg attachment unit 100 includes at least one seat 102 a set of pre-installed legs 103 (as shown in FIG. 2). The pre-installed legs used hereafter is defined as a set of legs which are manufactured by the original equipment manufacturer and is attached in the vehicle to house the seat at a required position.

The leg attachment unit 100 also includes at least one leg 104 operatively coupled to the corresponding at least one seat 102. The at least one leg 104 includes at least one leg sub-unit 106. The at least one leg sub-unit 106 includes a base section 108, a first section 110 of a first pre-defined shape and a second section 112 of a second pre-defined shape, wherein the first section 110 and the second section 112 are welded together at the base section 108 to obtain the at least one leg sub-unit 106.

In one exemplary embodiment, each of the first section, the second section and the base section may be composed of a metal. In such embodiment, each of the first section, the second section and the base section may be fabricated individually and may be welded together to obtain the at least one leg sub-unit 106. In such another embodiment, at least two of the first section, the second section and the base section may be fabricated along a single metal plate and may be welded to a remaining section to obtain the at least one leg sub-unit 106. Henceforth, any combination of plates or sections may be manufactured and welded together to obtain the at least one leg sub-unit 106.

In one embodiment, each of the first section and the second section includes a pre-defined number of edges to obtain the first pre-defined shape and the second pre-defined shape of the first section and the second section respectively. In one specific embodiment, the pre-defined number of edges may be one, two, three, or the like to obtain a required shape. In one exemplary embodiment, the pre-defined number of edges may be two, three, four, or the like to obtain a corresponding shape.

In one embodiment, the first pre-defined shape of the first section is obtained by making a tilt or a bend at one or more points on a single plate, or by joining a set of plates to obtain a tilt or a bend at one or more points to obtain the first pre-defined shape of the first section. More specifically, a single plate may be bent at different points to obtain the first pre-defined shape, or multiple plates of same or varied dimensions may be joined together to obtain the first pre-defined shape. In one exemplary embodiment, the tilt or bend at the one or more points may vary anywhere between an acute angle to an obtuse angle.

In one embodiment, the second pre-defined shape of the first section is obtained by making a tilt or a bend at one or more points on a single plate, or by joining a set of plates to obtain a tilt or a bend at one or more points to obtain the first pre-defined shape of the first section. More specifically, a single plate may be bent at different points to obtain the first pre-defined shape, or multiple plates of same or varied dimensions may be joined together to obtain the first pre-defined shape. In one exemplary embodiment, the tilt or bend at the one or more points may vary anywhere between an acute angle to an obtuse angle.

As used herein, the term ‘plate’ and/or ‘one or more plates’ corresponds to a respective section of each of the at leg sub-unit.

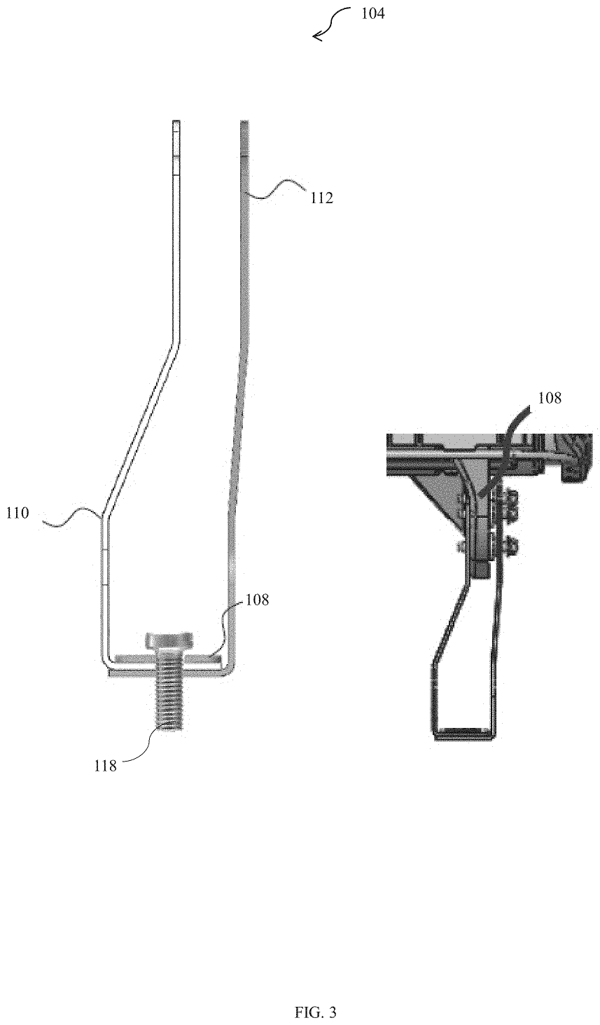

Furthermore, the base section 108 of each of the at least one leg 106 includes one or more set of holes 114, wherein the at least one seat 102 is fixed to a flooring 116 upon fixing a pilot 118 in the corresponding one or more set of holes 114 (as shown in FIG. 3). In one embodiment, the flooring may be one of an L track flooring, a wooden flooring, a metal flooring, or the like. The at least one leg unit 100 is housed on the flooring 116 inside the vehicle.

The set of pre-installed legs 103 are removed and is replaced by the corresponding at least one leg 106 for attachment of the at least one seat 102 in the vehicle.

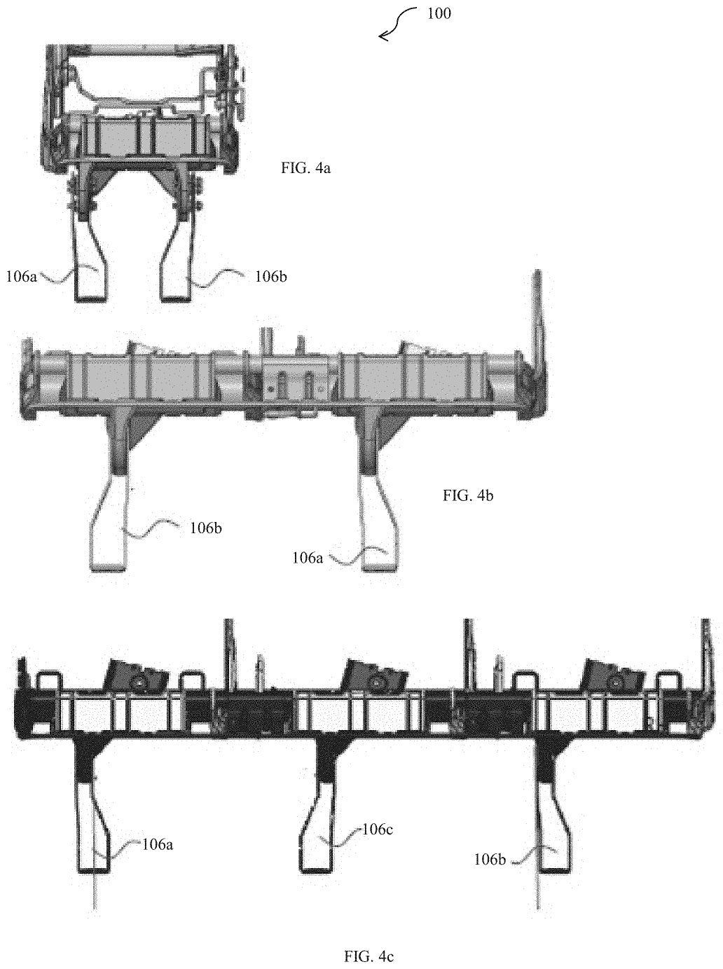

Turing to FIG. 2, in operation, each seat leg 103 of the OEM seat 102 is removed and is replaced by the corresponding at least one leg 106. In one embodiment, the first section 110 may be a mirror design of the second section 112. The obtained at least one leg 106 are used on single, double and triple seats (as shown in FIGS. 4a-4c).

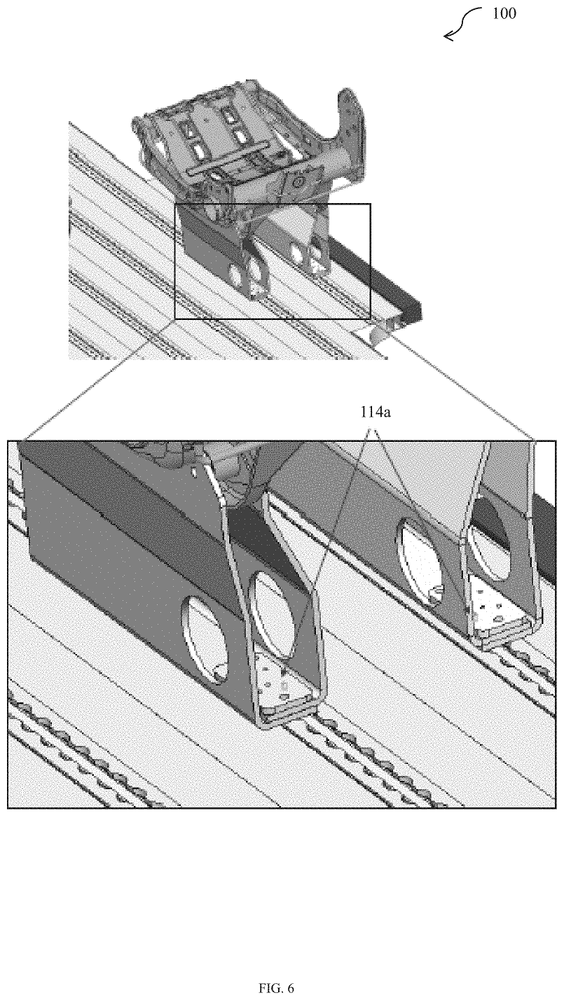

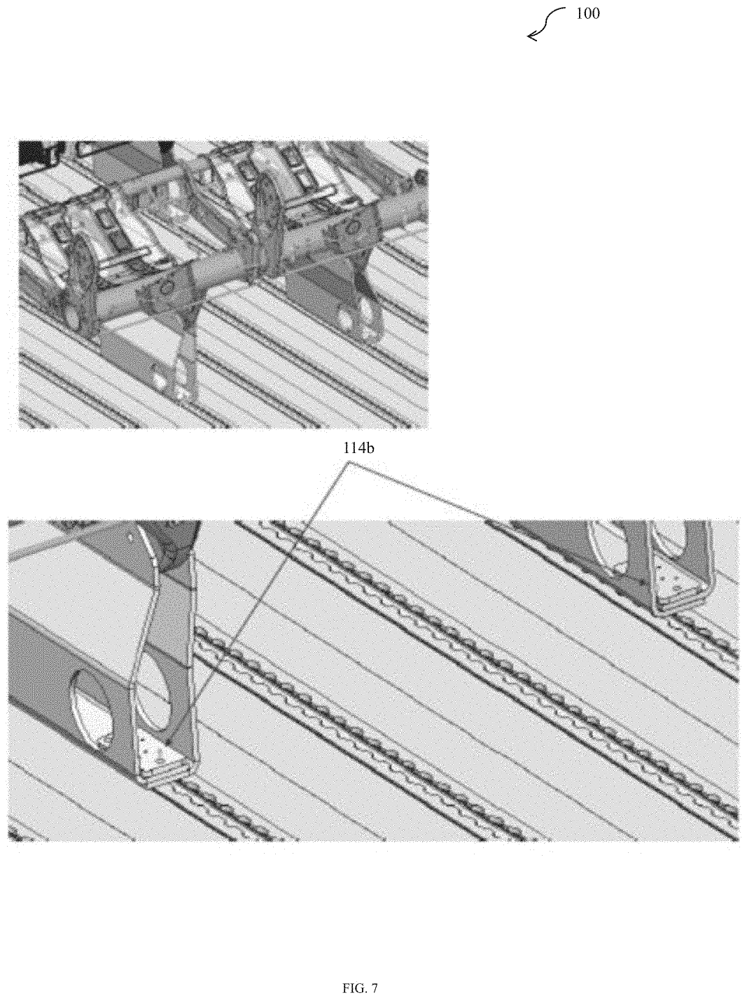

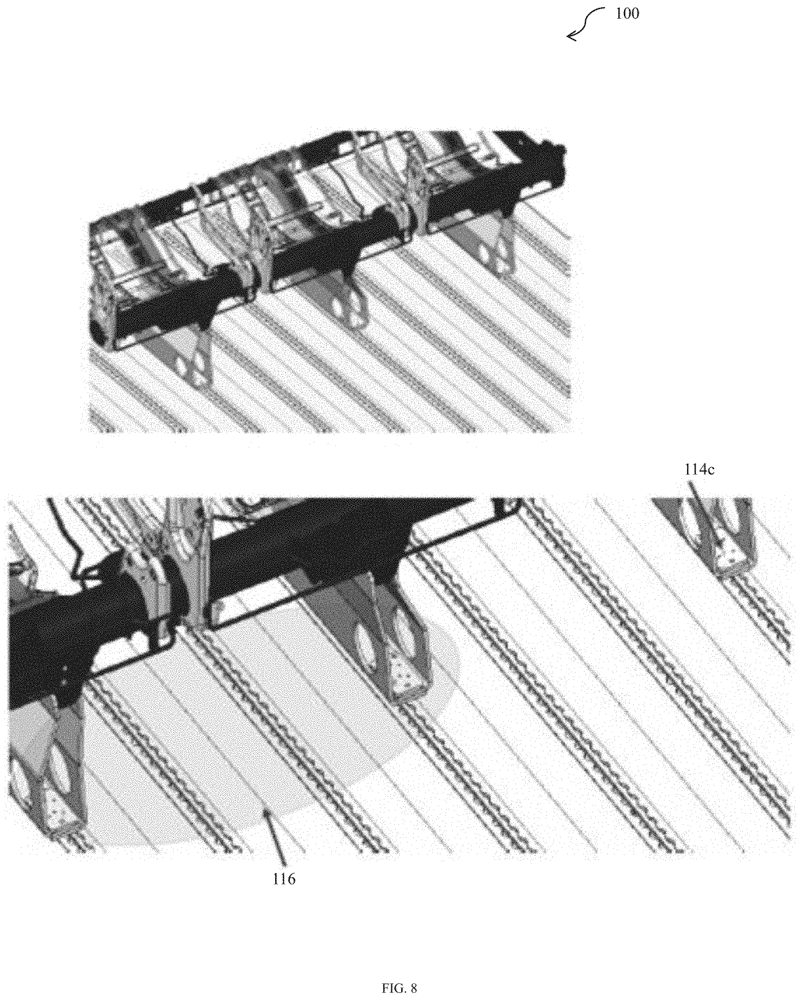

Turning to FIGS. 6, 7 and 8. Among the one or more set of holes 114, hole 114a is used for a single seat, hole 114b is used for a double seat and hole 114c is used on the triple seat. To enable the standardization and best supply and inventory management these holes must be drilled during the assembly.

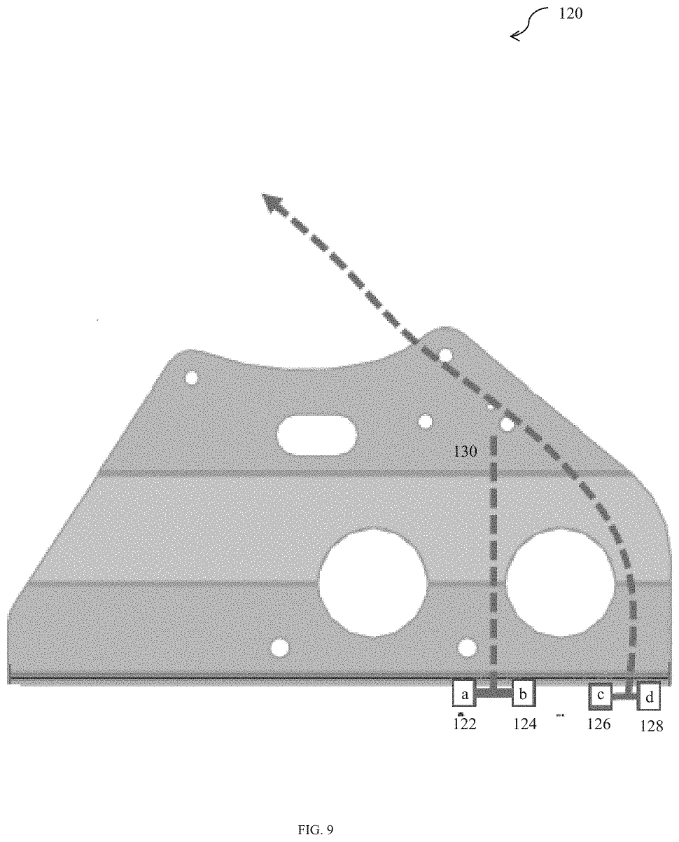

Turning to FIG. 9, the design 120 represents the leg 106 attached to the flooring 116 at 4 locations a 122, b 124, c 126, d 128. 130 is a perpendicular line straight from the point where the seat is connected to the leg at rear end.

In operation, the seat legs 103 are uninstalled from the OEM seats 102, the legs 106 and track 116 are discarded after saving the factory fasteners. The new legs 106 are installed back into the same location by using the fasteners 118 fastened vertically downwards on the flooring of the vehicle.

Furthermore, the seat legs are a weldment of 3 parts, the first section 110, the second section 112 and the base section 108. The first section 110, the second section 112 creates a sandwich of the seat base structure 108. The base section 108 helps to transfer FMVSS 207/210 pull load from the center of the bolt to the edge of base section 108 where it meets the bend in the first section 110.

FIGS. 4a-4c is a schematic representation of the leg attachment unit for one seat, two seats and three seats respectively of FIG. 1 in accordance with an embodiment of the present disclosure. A first leg 106 is installed on a left section and a second leg 106 is installed on a right section. This sequence is changed on the double seat (as shown in FIG. 4b), where the first leg 106a becomes the second leg 106b and the second leg 106b becomes the first leg 106a. This is done to establish a connection between the fixed seat leg spacing and the flooring 116. On the triple seat (as shown in FIG. 4c), the first leg 106 and a center leg 106c remain same as in the double seat, and an additional the second leg 106b is added on an extreme right section.

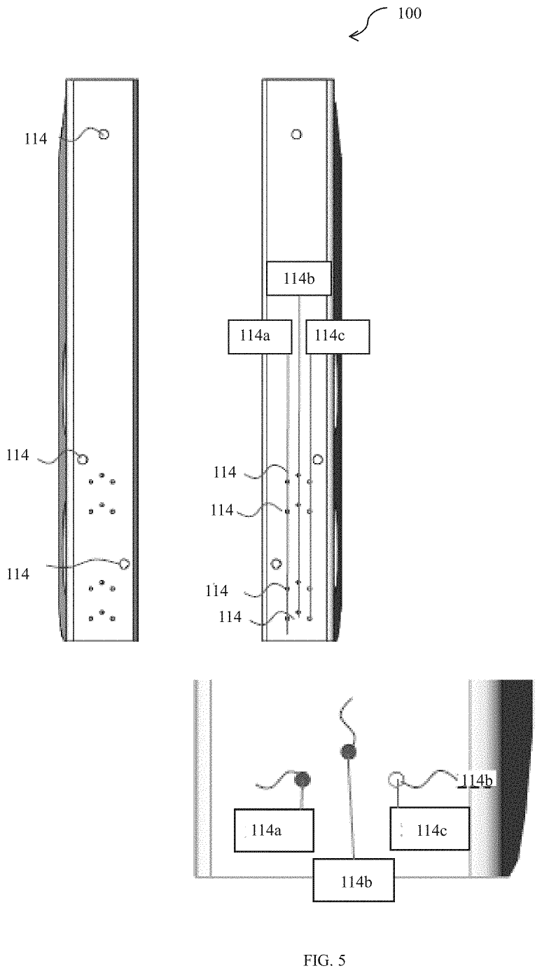

FIG. 5 is a schematic representation of three set of holes for installing for one seat, two seats and three seats of FIGS. 4a-4c in respectively accordance with an embodiment of the present disclosure. Set 1 114a on 106a and 106b, is used when installing on the single seat. Set 2 on 106a and 106b, is used when installing on a Triple Seat. Set 3 on 106a and 106b, is used when installing on a Double seat. Set1, 2, 3 may be drilled based on where the leg has to be installed and on which ford seat it is used.

As shown in the FIG. 9 the leg is a wider span structure with 4 holes to connect the seat leg to the floor. Bolts c 126, d 128 are on the right side of the perpendicular line 130, this location of bolts helps in distributing the load among Set 1 and Set 2 holes.

Various embodiments of the present disclosure enable the apparatus to use as a mobility vehicle for passenger travel, transportation of goods, transportation of passengers via a wheelchair, and the like, since the seat can be reused, the apparatus reduces the wastage, thereby making the system more flexible in application, reliable and efficient and also cost effective.

In addition, during accidents or any critical situation, the seat of the apparatus acts flexible, thereby putting less pressure on the flooring of the vehicle. In addition, since the bottom of the leg is flat, the seat can be placed easily on any surface.

Furthermore, the spacing between the seat legs for single, double and triple seat remains adjustable. For the seats to be used in mobility application, these seat legs are adjustable along the width of the seat, this flexible spacing on seats make them useable for mobility conversions.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

What is claimed:

1. A leg unit for attaching a seat in a vehicle, wherein the leg unit comprises:
at least one seat comprising a set of pre-installed legs,
characterized in that,
at least one leg is operatively coupled to the corresponding at least one seat, wherein each of the at least one leg comprises at least one leg sub-unit, wherein the at least one leg comprises at least three sections comprising a base section, a first section of a first pre-defined shape and a second section of a second pre-defined shape, wherein the first section and the second section are welded together at the base section to obtain the at least one leg sub-unit,
wherein the at least one leg is housed on a flooring inside the vehicle,
wherein the set of pre-installed legs are removed and is replaced by the corresponding at least one leg for attachment of the at least one seat in the vehicle; and
one or more set of holes, wherein the at least one seat is fixed to the flooring of the vehicle upon fixing one or more fasteners in the corresponding one or more set of holes to attach the at least one seat on the flooring of the vehicle.

2. The leg unit of claim 1, wherein the vehicle corresponds to a mobility transit vehicle used in transportation.

3. The leg unit of claim 1, wherein the at least three sections are obtained by at least two weldments.

4. The leg unit of claim 1, wherein each of the first section and the second section comprises a pre-defined number of edges to obtain the first pre-defined shape and the second pre-defined shape of the first section and the second section respectively.

5. The leg unit of claim 4, wherein the first pre-defined shape of the first section is obtained by making a tilt or a bend at one or more points on a single plate, or by joining a set of plates to obtain a tilt or a bend at one or more points to obtain the first pre-defined shape of the first section.

6. The leg unit of claim 4, wherein the second pre-defined shape of the first section is obtained by making a tilt or a bend at one or more points on a single plate, or by joining a set of plates to obtain a tilt or a bend at one or more points to obtain the first pre-defined shape of the first section.

7. The leg unit of claim 1, wherein one or more set of holes are designed based on number of the at least one seat.

8. The leg unit of claim 1, wherein the one or more set of holes are designed on at least one of a front end, a rear end or a combination thereof on the base section of each of the at least one leg sub-unit, wherein the one or more fasteners can be fixed at any desired location on the flooring in the vehicle via the one or more set of holes to attach the corresponding at least one seat.
